(19) United States
(12) Patent Application Publication
(10) Pub. No.: US 2026/0306894 A1
(43) Pub. Date: Oct. 8, 2026

(54) Method to Encapsulate Metal Organic Frameworks with Polymers to form Highly Porous Microbeads

(71) Applicant: TDA Research, Inc., Golden, CO (US)

(72) Inventors: Christopher Brian France, Arvada, CO (US); Gökhan Alptekin, Boulder, CO (US); Ambalavanan Jayaraman, Highlands Ranch, CO (US); Ewa Jonska-Muteba, Westminster, CO (US); Meredith Haanstad, Thornton, CO (US); Matthew Schaefer, Lakewood, CO (US)

(21) Appl. No.: 19/098,804

(22) Filed: Apr. 2, 2025

Related U.S. Application Data
(60) Provisional application No. 63/573,242, filed on Apr. 2, 2024.

(51) Int. Cl. A62D 3/35; A62D 101/02; B01J 31/16; B01J 35/00; B01J 35/40; B01J 35/53; B01J 35/58; B01J 37/02; B01J 37/03

(52) U.S. Cl. CPC A62D 3/35; B01J 31/1691; B01J 35/19; B01J 35/40; B01J 35/53; B01J 35/58; B01J 37/0211; B01J 37/036; A62D 2101/02

(57) ABSTRACT

A MOF formulation for protection against chemical warfare agents (CWAs) comprising 80-90% UiO-66-NH₂ by weight and 10-20 MOF-808 by weight. Also, a polymer-encapsulated catalyst comprising the MOF formulation in a polymer or hydrocolloid bead having a diameter of 100-800 μm, wherein the polymer-encapsulated catalyst comprises 70-85% MOF formulation by weight and 15-30% polymer by weight. Also, a method for encapsulating a catalyst with a polymer for protection against chemical warfare agents comprising the steps: generating a catalyst, wherein the catalyst absorbs and neutralizes toxic materials; dispersing the catalyst in a hydrocolloid solution, thereby forming a catalyst-hydrocolloid slurry; and, spraying the catalyst-hydrocolloid slurry through a spraying nozzle and into a gelling solution comprising a gelling agent. A method for encapsulating a catalyst with a polymer or use in textiles, further comprising collecting and drying a plurality of polymer-encapsulated catalysts from the gelling solution and adhering them to a textile.

### RELATED APPLICATIONS

The present application claims the benefit of provisional application 63/573,242, filed Apr. 2, 2024 (by Gökhan Alptekin, Ambalavanan Jayaraman, Ewa Muteba, Meredith Haanstad, and Lucas D. Ellis), which is incorporated by reference herein.

### STATEMENT OF GOVERNMENT INTEREST

This invention was made at least in part under funding from the United States Government, Contracts #W911SR-21-C-0023 and #W911SR-22-C-0013, awarded by the U.S. Army (SBIR Program). The government has certain rights in this invention.

### BACKGROUND OF THE INVENTION

Engineered materials capable of capturing and removing chemical-warfare agents (CWAs) and toxic industrial chemicals (TICs) are highly desirable for protective textile applications. Current personal protection garments for CWAs are either: 1) carbon-based air-permeable suits (e.g. Saratoga Hammer Suit), which physically adsorb nerve and vesicant agents (Adanur 1995), or 2) impermeable protective barriers such as Teflon-based suits, which require built-in breathing units as air supply (Lu 2017). Neither system is capable of self-detoxification of CWAs. Methods to incorporate reactive materials that can detoxify/neutralize CWAs onto textiles have long been sought after (Lu 2017, Chen 2019).

Recently, metal-organic framework (MOF) materials have shown ability as sorbents and catalysts for capturing and neutralizing nerve agents and TICs (Peterson 2013, Mondloch 2015, Lu 2017, Peterson 2017, Chen 2019). MOFs are porous materials composed of inorganic metal nodes connected by organic linkers to form crystalline structures. The zirconium-based MOF UiO-66-NH₂ (EP3197902A1) has the ability to catalyze the hydrolysis of organophosphates (Lu 2017).

Recent efforts have focused on integrating Zr-based MOFs into free-standing substrates or textiles. For example, Lu (2017) has shown electrospinning as a scalable process to produce nonwoven MOF/polymer nanofibers for textile applications. Integrating MOFs with the polymer fibers provided better performing materials by combining the desirable properties of the fibers (e.g., fast moisture vapor transport rates and particulate filtration), with the chemical filtration capability provided by the MOF. Electrospinning fabric materials with MOFs would provide fabrics with additional porosity and reactivity toward target chemicals. However, one of the challenging aspects of engineering MOFs onto substrates such as fibers is finding suitable polymer/MOF pairs. The polymer needs to encapsulate and strongly adhere to the MOF particle, but at the same time it needs to let the CWA access to the MOF's reactive surface and pores. Furthermore, this external porous polymer shell also needs to adhere strongly to the fabric fibers and not wash away during laundry or general use.

### SUMMARY OF THE INVENTION

The present invention overcomes the limitations in the prior art by utilizing a hydrocolloid gelation method to encapsulate selected MOFs (UiO-66-NH₂ or other MOFs, preferably a combination of UiO-66-NH₂ and MOF-808) into porous polymer beads. This may be accomplished through the use of a sprayer, such as electrospray, shown in FIGS. 1A and 1B. The method will also work effectively with reactive metal oxides/hydroxides, such as zirconium hydroxide (Zr(OH)₂). These MOF/polymer beads can be entrapped in the fibrous structure in a manner similar to the way MOF crystallites are entrapped in the electrospun fibers. But, because the porous polymer surrounding the MOF crystallites provides mechanical strength to the MOF/polymer composite, there is lower risk that the MOF will disintegrate into smaller size particles and wash away during use or laundry. The polymer-encapsulated MOF beads may be adhered to the fabric of textiles with an elastomer adhesive that does not completely coat or destroy the surface area of the bead (maximum reactivity with chemical warfare agents is retained).

The present disclosure teaches a MOF formulation for protection against chemical warfare agents (CWAs) comprising: a) UiO-NH₂; and, b) MOF-808; wherein, the MOF formulation comprises 80-90% UiO-66-NH₂ by weight and 10-20% MOF-808 by weight. Preferably, the MOF formulation is prepared by a single pot synthesis. The MOF may reduce the concentration of VX or HD in solution by at least 75% when 250 g of MOF formulation is in contact with 20 μL of VX or HD in solution for 24 hours. Preferably, at least 80% or at least 85%.

The present disclosure also provides a polymer-encapsulated catalyst for protection against CWAs comprising: a) the MOF formulation described above (80-90% UiO-NH₂ by weight and 10-20% MOF-808 by weight); and, b) a polymer shell surrounding the MOF formulation; wherein, the polymer-encapsulated catalyst is a rounded bead; wherein, the polymer-encapsulated catalyst has a diameter of 100-800 μm; and, wherein, the polymer-encapsulated catalyst comprises 70-85% MOF formulation by weight and 15-30% polymer by weight. The polymer shell preferably comprises a hydrocolloid. The hydrocolloid may be selected from the group comprising: agars, starches, celluloses, xanthan, gelatins, casein, alginates, carrageenans, amino sugars, and pectins. Preferably, the polymer-encapsulated catalyst has a diameter of 200-400 μm.

This disclosure also provides a method for encapsulating a catalyst with a polymer for protection against CWAs comprising the steps: a) generating a catalyst, wherein the catalyst absorbs and neutralizes toxic materials; b) dispersing the catalyst in a hydrocolloid solution, thereby forming a catalyst-hydrocolloid slurry; and, c) spraying the catalyst-hydrocolloid slurry through a spraying nozzle and into a gelling solution comprising a gelling agent. The catalyst may be at least one MOF. Preferably, it is a combination of UiO-66-NH₂ and MOF-808. More preferably, the catalyst comprises 80-90% UiO-66-NH₂ by weight and 10-20% MOF-808 by weight. Also preferably, generating the catalyst comprises co-generating UiO-66-NH₂ and MOF-808 in a single pot synthesis.

In the case where the catalyst is a MOF, the MOF compared to the hydrocolloid may have a weight percent loading of 70-85%, or more preferably 85%. The hydrocolloid may be selected from the group comprising: agars, starches, celluloses, xanthan, gelatins, casein, alginates, carrageenans, amino sugars, and pectins. The catalyst-hydrocolloid slurry may further comprise water, wherein the MOF compared to the water has a weight percent loading of 3-15%.

In an embodiment, the spraying nozzle is either an electrospray nozzle or a pneumatic spray nozzle. A pneumatic sprayer is preferred, especially for scaled-up embodiments. Other spraying nozzles may also be used such that they are functional to produce small beads with the preferred diameters (100-800 μm). In an embodiment, using an electrospray nozzle, electrospraying the catalyst-hydrocolloid slurry into the gelling solution further comprises electrospraying the catalyst-hydrocolloid slurry into the gelling solution with an applied voltage of 5-35 kV. More preferably, the applied voltage is 25 kV. The electrospray nozzle may comprise a nozzle diameter, wherein the nozzle diameter is 0.5-2.5 mm.

In an embodiment, the gelling agent comprises any Group 2 multivalent ion. The gelling agent may comprise Ca²⁺. More specifically, the gelling agent may be Ca(NO₃)₂ or CaCl₂.

The disclosed method may further comprise d) collecting a plurality of polymer-encapsulated catalysts from the gelling solution, wherein each polymer-encapsulated catalyst has a diameter of 100-800 μm. In an embodiment, the formed beads (polymer-encapsulated catalysts) have a diameter of 100-500 μm. In another embodiment, the formed beads have a diameter of 300-400 μm. The polymer-encapsulated catalysts preferably comprise 70-85% MOF formulation by weight and 15-30% polymer by weight.

The present disclosure further teaches a method for encapsulating metal organic frameworks (MOFs) with a polymer for use in textiles, the steps comprising: a) generating a catalyst, wherein the catalyst is reactive with nerve and blister chemical warfare agents; b) dispersing the catalyst in a hydrocolloid solution, thereby forming a catalyst-hydrocolloid slurry; c) spraying the catalyst-hydrocolloid slurry through a spraying nozzle and into a gelling solution comprising a gelling agent; d) collecting and drying a plurality of polymer-encapsulated catalysts from the gelling solution, wherein each polymer-encapsulated catalyst has a diameter of 100-800 μm; and, e) adhering the plurality of polymer-encapsulated catalysts to a textile such that the textile retains its flexibility, and such that the textile can be assembled into a wearable suit or garment, wherein the wearable suit or garment protects a wearer in an environment contaminated with nerve and blister chemical warfare agents.

Preferably, adhering the plurality of polymer-encapsulated catalysts to a textile comprises using an adhesive to attach the polymer-encapsulated catalysts to the textile, wherein the adhesive does not completely coat or destroy the surface area of the polymer-encapsulated catalysts. The adhesive may be a thermoplastic elastomer adhesive, such as PEBAX®. Adhering the plurality of MOF microbeads to a textile may comprise functionalizing and stabilizing the textile with the plurality of polymer-encapsulated catalyst microbeads through at least one of chemical binding, hot-pressing, gluing, and using an adhesive. In an embodiment, adhering the plurality of polymer-encapsulated catalyst microbeads to a textile comprises first using an elastomer adhesive for adhering the polymer-encapsulated catalyst microbeads to the textile, then hot-pressing the textile for stabilizing the textile.

Preferably, the catalyst is at least one MOF. More preferably the catalyst is a combination of more than one MOF, or a combination of UiO-66-NH₂ and MOF-808, in a specific embodiment where the catalyst is 80-90% UiO-66-NH₂ by weight and 10-20% MOF-808 by weight. Preferably, the textile is capable of decontaminating chemical warfare agents or simulants. Preferably the textile protects a wearer from chemical warfare agents, especially nerve and blister agents such as HD and VX. The chemical warfare agents or simulants may also comprise DMMP, DMNP, DEVX, Paraoxon, or 2-CEPS.

Additionally, the present disclosure teaches a method for encapsulating catalysts with a polymer for use in gas separation devices, the steps comprising: providing a catalyst; dispersing the catalyst in a hydrocolloid solution comprising a hydrocolloid and forming a catalyst-hydrocolloid slurry, wherein the catalyst compared to the hydrocolloid has a weight percent loading of 70-85%; providing an spraying nozzle; feeding the catalyst-hydrocolloid slurry into the spray nozzle; providing a gelling solution comprising a gelling agent; spraying the catalyst-hydrocolloid slurry into the gelling solution; removing a plurality of microbeads from the gelling solution, wherein each microbead has a diameter of 100-800 μm; providing a gas separation device with a fixed bed or a cartridge; and, inserting the at least one catalyst microbeads into the fixed bed or the cartridge. This method may also comprise concentrating a gas stream through the gas separation device. The gas stream may comprise ammonia. The gas stream may comprise DMMP.

### BRIEF DESCRIPTION OF THE FIGURES

FIG. 1A: A perspective view of the theory of electrospray.

FIG. 1B: A perspective view of an electrospray apparatus constructed for forming polymer encapsulated catalysts.

FIG. 2: Microbeads formed from varying nozzle diameter sizes.

FIG. 3A: A perspective view of a nozzle for the electrospray system when no voltage is applied.

FIG. 3B: A perspective view of a nozzle for the electrospray system when 25 kV is applied.

FIG. 3C: A perspective view of a tube-in-tube approach with resulting polymer-encapsulated beads.

FIG. 3D: A perspective view of polymer-encapsulated beads when no voltage is applied.

FIG. 3E: A perspective view of polymer-encapsulated beads when 25 kV is applied.

FIG. 3F: A perspective view of polymer-encapsulated beads from the tube-in-tube approach.

FIG. 4A: Optimization of applied voltage to the electrospray nozzle.

FIG. 4B: Optimization of diameter of the electrospray nozzle.

FIG. 5A: Optimization of MOF to water ratio.

FIG. 5B: Optimization of MOF loading to polymer encapsulant ratio.

FIG. 6A: Microbeads containing sodium alginate and UiO-66-NH₂, where solution prior to spray was lower viscosity.

FIG. 6B: Microbeads containing sodium alginate and UiO-66-NH₂, where solution prior to spray was higher viscosity.

FIG. 7: DMMP adsorption breakthrough curves.

FIG. 8A: Method for adhering MOF microbeads to Saratoga suit. Adhering the fabric interfacing, with additional interfacing, with elastomer adhesive.

FIG. 8B: Method for adhering MOF microbeads to Saratoga suit. Adhering the fabric interfacing, with additional interfacing, with elastomer adhesive.

FIG. 8C: Method for adhering MOF microbeads to Saratoga suit. Adhering the fabric interfacing, with additional interfacing, with alginate binder.

FIG. 8D: Adhering the fabric inner surface with elastomer adhesive.

FIG. 8E: Adhering the fabric inner surface with a polyurethane binder with additional interfacing.

FIG. 8F: Adhering the fabric inner surface with fabric adhesive tape.

FIG. 9A: Carbon microbeads on Saratoga Hammer Suit via optical image.

FIG. 9B: Carbon microbeads on Saratoga Hammer Suit via 3D rendering.

FIG. 9C: MOF microbead functionalized fabric via optical image.

FIG. 9D: MOF microbead functionalized fabric via 3D rendering.

FIG. 10: Schematic of fabric functionalization procedure.

FIG. 11: DMNP hydrolysis to p-nitrophenoxide.

FIG. 12: DMNP hydrolysis performance of native UiO-66-NH₂ powder and synthesized polymer-encapsulated MOF beads.

FIG. 13: Particle size distribution of MOF beads formed by pneumatic spray technique.

FIG. 14: Reactivity of mixed MOFs against HD, VX, GD.

### DETAILED DESCRIPTION OF THE INVENTION

Unless defined otherwise, all technical and scientific terms used herein have the same meaning as commonly understood by one of the ordinary skill in the art to which the invention belongs.

A reliable means to encapsulate metal organic frameworks in polymers using a proprietary formulation (recipe) and synthesis method leveraging a custom electrospray or pneumatic spray system is disclosed herein. Alternate spraying methods may be used to achieve the same 100-800 μm diameter beads.

In the Summary of the Invention above and the Detailed Description of the Invention, and in the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

“Comprises” and grammatical equivalents thereof are used herein to mean that other components, ingredients, steps, etc. are optionally present. For example, an article ‘comprising’ (or ‘which comprises’) component A, B, and C can consist of (i.e., contain only) components A, B, and C, or can contain not only components A, B, and C but also one or more other components.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending on the variable being defined). For example, “at most 4” means 4 or less than 4, and “at most 40%” means 40% or less than 40%. When, in this specification, a range is given as “(a first number) to (a second number)” or “(a first number)-(“a second number)”, this means a range whose lower limit is the first number and whose upper limit is the second number. For example, “70-85%” means a range whose lower limit is 70% and whose upper limit is 85%, where both 70% and 85% are included in that range.

The term “chemical warfare agent” means a chemical toxin designed to cause harm through their properties, with the four main categories including nerve agents, blister agents, blood agents, and choking agents.

The term “encapsulating” means surrounding and protecting so the encapsulated catalyst has increased mechanical strength and decreased risk of disintegration, while maintaining sufficient porosity so the catalyst maintains function.

The term “hydrocolloid” means a hydrophilic polymer system dispersed in water, and capable of forming a gel upon cooling or contact with multivalent cations. Nonlimiting examples include agars, starches, celluloses, xanthan, casein, alginates, carrageenans, amino sugars, and pectins.

The term “reduces the concentration” of an agent means that the MOF formulation removes the agent from the immediate environment by capturing, neutralizing, detoxifying, holding, or reacting with the agent, or any other method of reducing the toxicity of an agent.

The term “weight percent loading” in the claims means the percent of weight that the specified material comprises out of the total weight of the named materials, which together are 100%. For example, “the MOF compared to the hydrocolloid has a weight percent loading of 85%” means that the total combined weight of the MOF and the hydrocolloid is 100%, of which the weight of only the MOF comprises 85% and the weight of only the hydrocolloid comprises 15%. This example would form “85% MOF microbeads”, where the 85% refers to the initial weight percent loading.

The term “single pot synthesis” or “one pot synthesis” means multiple chemical reactions for formation of multiple products take place in a single reaction vessel, rather than being synthesized separately and then combined. Single pot syntheses are beneficial in terms of saved time, materials, and other practical considerations. They are preferred for scaling up processes.

The term “spraying nozzle” means a channel capable of delivering a liquid through and spraying in aerosol form. The spraying nozzle is connected on the back-end to a hose, pump, liquid container, or other channel or connector to allow the passage of liquid out and to exit in small droplets.

The term “electrospray nozzle” means a small channel connected to high voltage which is capable of delivering a liquid through and out the channel in a spray or aerosol form, forming small charged droplets. The electrospray nozzle may be connected on the back-end to a hose, a pump, a syringe, a syringe pump, a liquid container, or any equivalent. The diameter of the electrospray nozzle refers to the diameter at the outlet of the nozzle, where the liquid exits in spray or aerosol form.

The term “pneumatic spray nozzle” means a small channel that uses a high velocity flow of compressed air to spray a liquid passing through the channel into a fine spray of very small droplets.

The term “gelling agent” means a multi-valent cation which causes a chosen hydrocolloid to form a gel upon coming in contact with the cation—this may occur through hydrogen bonding, hydrophobic association, cation mediated cross-linking, or other equivalents. The gelling agent is responsible for the rapid hardening of the hydrocolloid, which encapsulates the MOF in a polymer shell. Hydrocolloid gelation and gelling agents are understood in the art.

The term “electrospraying” means employing electricity to a liquid solution flowing through a nozzle connected to high voltage, generating tiny charged droplets, as is the common definition of the technique.

The term “co-generating” means using synthesis techniques to produce more than one product at the same time and in the same reaction vessel, rather than using separate workups in multiple reaction vessels.

The term “weight ratio” means the percent loading (in all uses in the claims, the percent loading of the MOF), which is a fraction or percent relating to the mass in grams of MOF starting material to the mass in grams of the other parameter as a starting material.

The term “gelling agent” means a substance that, when contacting a polymer or hydrocolloid, forms a gel-like texture or consistency by forming a network of molecules with the polymer or hydrocolloid. The gelling agent allows the polymer shell to form around the MOF. The gelling agent may contain ions from a multivalent group 2 metal, such as Ca²⁺, such as non-limiting examples Ca(NO₃)₂ or CaCl₂.

The term “adhering” means attaching the MOF microbeads to a textile in a manner that maintains reactivity or functionality of the MOFs, and secures the microbeads to the textile so they do not readily disintegrate or fall off the textile when disturbed by any type of external contact to the textile.

The term “textile” means any type of cloth or woven fabric, which may comprise any natural or synthetic materials including but not limited to cotton, nylon, polyester, rayon, linen, spandex, and the like, and can be incorporated into a garment. Preferably, the textile can be assembled into a suit to protect the wearer in a contaminated environment.

Hydrocolloids such as agars, starches, celluloses, xanthan, gelatins, casein, alginates, carrageenans, amino sugars, and pectins form gels as they cool or contact multi-valent cations like Ca²⁺. For example, aqueous dispersions containing dissolved alginate or amino sugars will gel when introduced to a gel-inducing agent, such as multivalent ions from Group 2 metals, like Ca²⁺. The present disclosure describes a unique electro-spraying method to produce microbeads of polymer encapsulated MOF, taking advantage of this gelation technique.

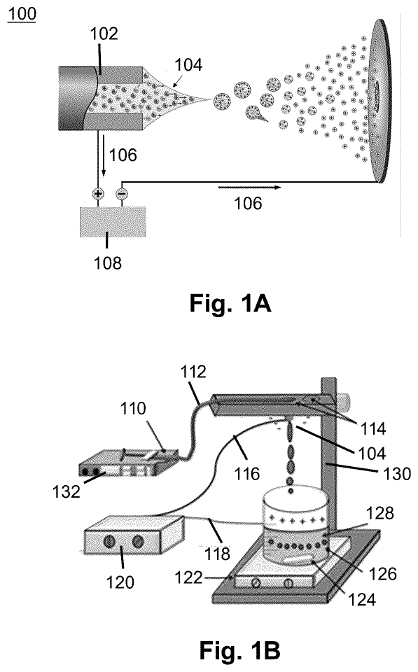

FIGS. 1A and 1B show the use of a sprayer 100, such as electrospray. The sprayer 100 is made up of a nozzle 102, a Taylor Cone 104, and electrons 106 moving through a high voltage power supply 108. FIG. 1B shows the sprayer 100 in a larger context. In an embodiment, a pump 132 may be secured to a syringe with solution 110 which is attached to a conveying hose 112. The conveying hose is supported by a support structure 130. On the top support structure 130 is at least one opening for needles 114. A power source 120 is connected to a negative electrode 116 and an earth electrode 118. The negative electrode 116 connects the power source 120 to the nozzle 102 to form the Taylor Cone 104. The earth electrode 118 connects the power source 120 to the crosslinking solution 128. The support structure 130 may be anchored. On the base of the support structure 130 is a stir plate 122. On the stir plate 122 is a container containing a magnet 124, droplets 126 and the crosslinking solution 128. The droplets 126 are the product of the Taylor Cone 104.

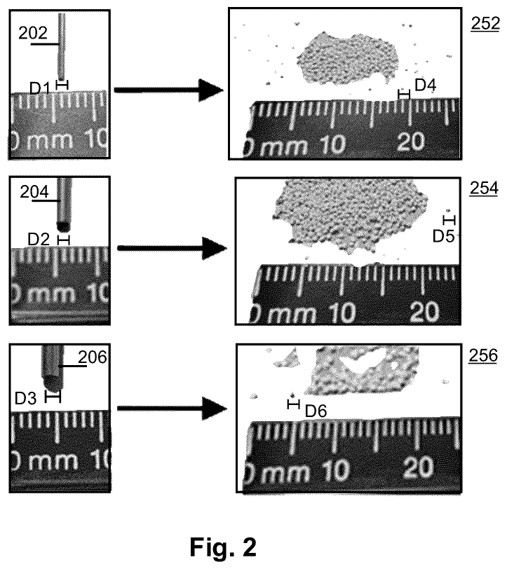

Using a bench-scale electro-spraying system, we prepared 100-500 μm encapsulated microbeads with 70 to 85% wt. active MOF content surrounded by a highly porous, yet strong, polymer shell. Preferably, the bead comprises more than one MOF in a ratio that obtains broad reactivity against multiple chemical warfare agents. FIG. 2 shows the different size microbeads prepared by changing the nozzle size, which holding all other variables constant (e.g., solution properties, nozzle voltage, etc.). Nozzle 1 202 has a diameter D1 between 0 and 2 mm, with resulting microbeads 252 with a diameter D4 between 0 and 2 mm. Nozzle 2 204 has a diameter D2 between 1 and 3 mm, with resulting microbeads 254 with a diameter D5 between 0 and 2 mm. Nozzle 3 206 has a diameter of between 1 and 3 mm, with resulting microbeads 256 with a diameter D6 between 0 and 2 mm.

When preparing the microspheres, there is a greater risk of closing the small nozzles, as the difference between the size of any agglomerated MOF particles and the injection port narrows. The present method addresses this problem by using an electro-spraying technique or a pneumatic spraying technique to disperse the MOF/hydrocolloid solution. This method allows various nozzle diameters to be explored for different polymer/MOF pairs, due to the flexibility of this technique. Other spraying techniques may be used.

The pressure during processing (pelletization, pumping slurry, etc.) must be minimized due to the delicate nature of the MOF structure. Porous materials like MOFs and mesoporous silicas have extremely large surface areas, because the walls of the pores are only a few atoms thick. Therefore, high pressure processing (including pelletization and extrusion) can cause the porous structure to collapse. To address this problem, the method disclosed herein uses a low-pressure pump with the electrospray nozzle. Normally, droplets are formed from the nozzles by forcing the slurry through the nozzle at high pressure—the energy from the pressure causes the droplets to release from the nozzle. Instead, in electro-spraying, a high voltage power supply is used to generate extremely high charge densities in the solution as it passes through the nozzle. The high static charge density overcomes the surface tension, resulting in a low-pressure spray.

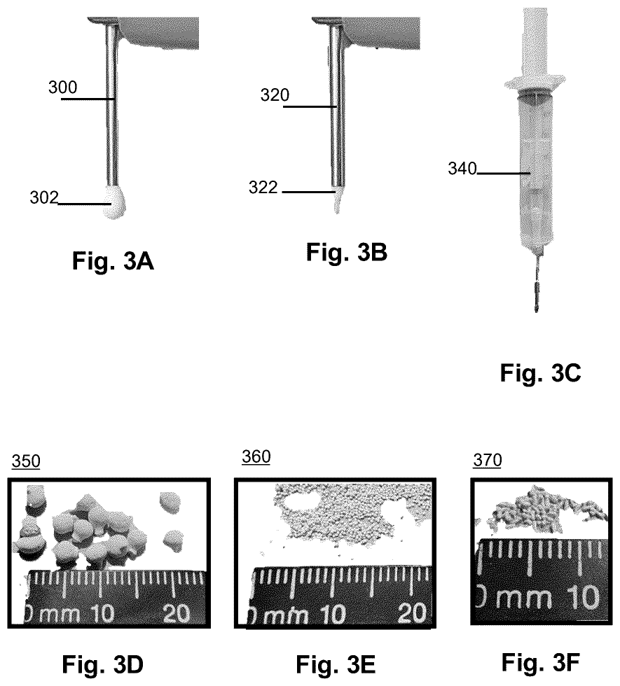

The constructed electrospray and pneumatic spray systems produce microbeads of consistent diameter, MOF composition, and activity. Images of the nozzle of the constructed electrospray system, and the resulting microbeads, are shown in FIGS. 3A-3F. Notably, the electrospray voltage (25 kV) is applied to a nozzle 320 to form a Taylor Cone 322 in FIG. 3B, with the resulting microspheres 360 with 100-500 μm in diameter shown in FIG. 3E. When no voltage is applied to a nozzle 300, a droplet 302 forms, shown in FIG. 3A, beads 350 ^{~}3 mm in diameter are produced as shown in FIG. 3D. Unique system geometries were also tested, like a manual Tube-in-Tube approach 340 shown in FIG. 3C and producing rods 370 with a diameter between 300-500 μm and varying lengths shown in FIG. 3F.

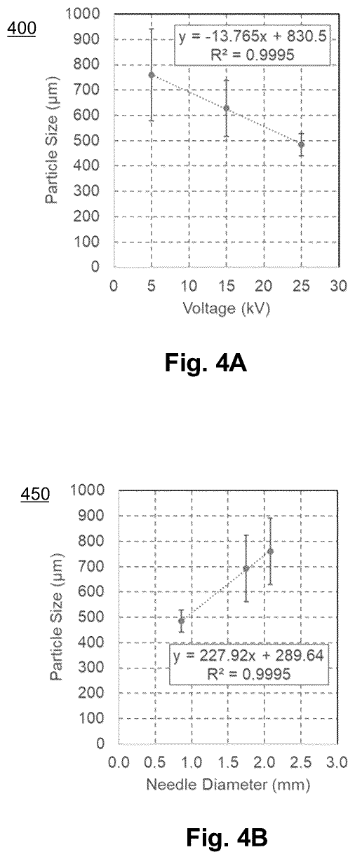

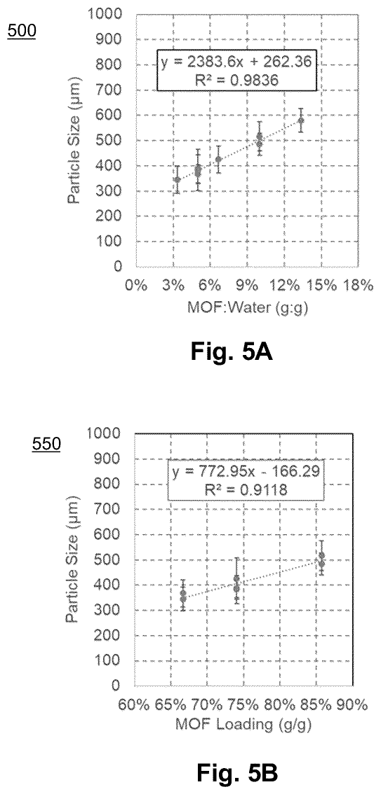

Electrospray process parameters and spray solution properties must be defined to produce the smallest MOF microbeads. Key electrospray process parameters include applied voltage and needle diameter. A particular set of these parameters are shown in FIGS. 4A and 4B. FIG. 4A shows a graph 400 demonstrating the relationship between the voltage and the particle size. FIG. 4B shows a graph 450 demonstrating the relationship between needle diameter and particle size. For spray solution properties, the effect of varying the ratio of MOF to water as well as the ratio of included polymer encapsulant to loaded MOF were studied. Preliminary optimization of these properties is shown in FIGS. 5A and 5B. FIG. 5A shows a graph 500 demonstrating the relationship between MOF to water and the particle size. FIG. 5B shows a graph 550 demonstrating the relationship between the loaded MOF and the particle size.

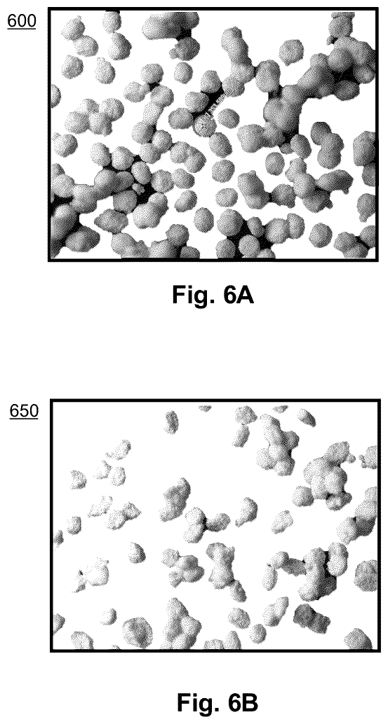

In the electro-spraying based microbead formation process, first a large batch of reactive MOF catalyst is synthesized. In a typical synthesis, the MOF is crystallized from the solution, providing a recoverable filtrate cake, which is washed with methanol to remove any remaining high boiling solvents. The recovered solids are then washed with water to remove the low boiling solvent. The filter cake is then re-slurried in water. To ensure homogeneous suspension of the very fine particles, the slurry is continuously stirred under ultrasonication. Then the MOF is dispersed into the desired hydrocolloid, forming a slurry, which can be fed to an electrospray nozzle; the droplet size is controlled by controlling the nozzle voltage, nozzle diameter, and solution characteristics (e.g. viscosity, solids content, etc.). The droplets fall down and contact the gelling solution containing the gelling agent (e.g., Ca(NO3)2 or CaCl2). The gelling agent rapidly hardens the hydrocolloid in the droplets, forming a porous polymer layer that completely encapsulates the MOF. The addition rate of the slurry and the duration of each pulse through the nozzle is controlled to ensure sufficient time is provided for the polymerization and to allow the formed particles to be gravimetrically removed. By varying the nozzle voltages (5-35 kV), nozzle diameter, and solution characteristics (i.e. viscosity, solids content, etc.), microbead particles are formed with tunable specific size and shape characteristics, like sphericity and roundness. Optical images of sodium alginate and UiO-66-NH₂ microbeads are shown in FIGS. 6A and 6B, where the microbeads 600 in FIG. 6A were formed from a lower viscosity solution than the microbeads 650 shown in FIG. 6B.

A preferred method for forming microbeads is using a pneumatic spray instead of electrospray. A pneumatic spray works better for making the alginate beads than electrospray when scaling up the process, but alternate spraying methods may be used. In our pneumatic spray method, we use a dual spray nozzle system where low-pressure air flow is used to create a mist of small droplets of alginate MOF mixture, which then drop into a calcium containing solution to solidify the alginate beads.

In an embodiment using the pneumatic sprayer, a full-cone no-drip misting nozzle is connected to a syringe pump containing the UiO66-NH2/alginate solution, and this solution is injected into the spray nozzle at a rate of 25 mL/hr. To mist the injected solution, the nozzle simultaneously flows pressurized air to mist the solution as it is dispensed from the nozzle. The pressure used here was 0.5 psi. The resulting mist is then directed downwards, allowing it to fall a short distance into a 2% CaCl₂ stirred bath where the resulting beads dwell until solidified, which may be 40 minutes.

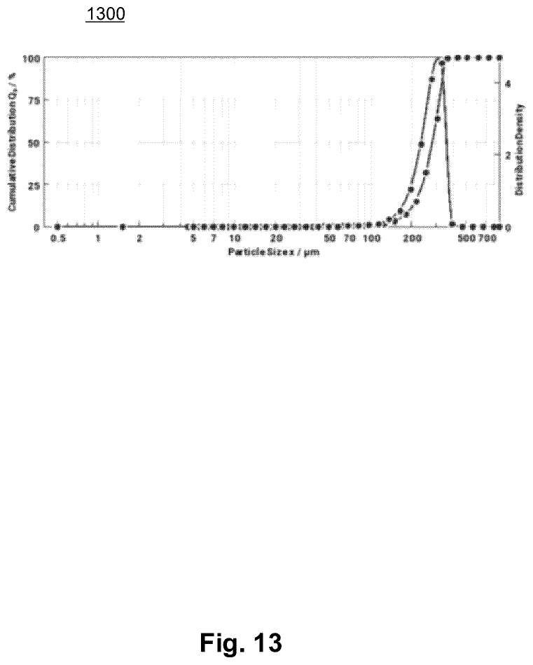

The particle size distribution of the pneumatic sprayed beads is shown in a graph 1300 in FIG. 13. The volume mean diameter (VMD) of the sprayed bead sample 1399-15B was determined to be 276.03 μm, which is comparable to the electrosprayed beads (VMD of 280.52 μm). The distribution of bead sizes generated is very narrow. Beads produced by the pneumatic spray nozzle method can be more quickly produced and have a more consistent size than those made with the electrospray method.

The present method can produce at least 1 kg/hr, preferably at least 2 kg/hr of the solid beads. The diameter of the beads increases with faster flow rates, and particle size analysis shows that at a constant pressure of 0.4 psi the smallest beads made from a 100 mL/hr flow rate had a median particle side of 167.97 μm, and 400 mL/hr produced the largest beads with a median diameter of 263.47 μm.

To improve the flowability, the ability to pump the solution to the spray nozzle, the solution may be sonicated, optionally for 30 minutes, to better disperse the MOF particles in the alginate binder prior to spraying. This may result in a slight loss in surface area (4.21% loss compared to 2.49% in practice).

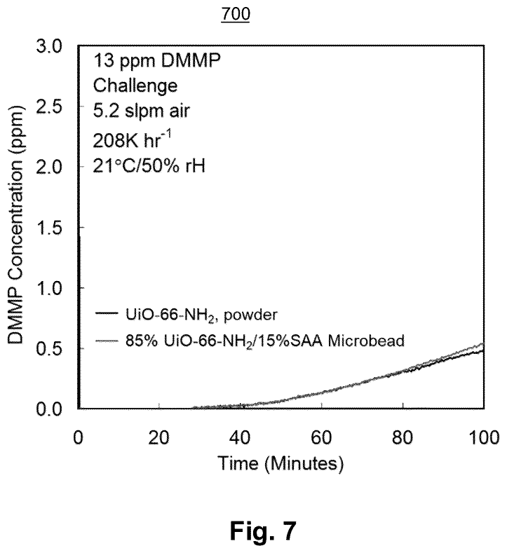

Through extensive characterization, it is shown that the surface area and crystal structure in the encapsulated MOFs are retained in the present encapsulation process. The process of mixing and spraying to produce the beads does not destroy the MOF structure, as evidenced by XRD patterns of both the powder and bead samples. Furthermore, in bench-scale evaluations, it is shown that adsorptive properties of the native MOF and polymer encapsulated microbeads are highly comparable. The chemical activity tests included the adsorption of ammonia (NH₃) and Dimethyl methyl phosphonate (DMMP) (acting as a simulant) where the loss of capacity due to polymer encapsulation was almost negligible. FIG. 7 shows the comparison of the breakthrough profiles of the UiO-66-NH₂ powder and the polymer encapsulated MOF (85% UiO-66-NH₂/15% SAA, produced via disclosed electrospray method) with almost identical performance. Similarly, evaluations to assess the hydrolysis activity for dimethyl (4-nitrophenyl) phosphate (DMNP, a simulant also known as methyl paraoxon) with the microbeads closely matched to that of the native MOF powder.

The microspheres also have application in fixed beds or cartridges for gas purification or separation. A series of fixed bed ammonia adsorption experiments have confirmed the performance of the different MOF microbead composites. Table 1 shows results of ammonia adsorption breakthrough tests with UiO-66-NH₂ and CuBTC MOFs. Each experiment included adsorption of 20 ppm ammonia in air at ambient temperature and was run until ammonia breakthrough was observed. Tests were performed at 20 ppm NH3 and GHSV (gas hourly space velocity) of 36,000 h-1. Ammonia breakthrough capacities were measured at 1 ppm ammonia. All of the sorbents were activated in dry air at 110° C. for 4 hr with a temperature ramp rate of 1° C./min. As shown, the latest 15% SAA-UiO-66-NH2 samples showed better NH3 capacity (0.92% w/w; 2.32 mg/cc) than the baseline UiO-66-NH₂ sample (0.87% w/w; 3.04 mg/cc) prepared and granulated as press pills on a gravimetric basis. These polymer encapsulated MOF samples retained >75% of the original capacity on a volumetric basis.

TABLE 1

| | MOF Content, | | | | | |
|---|---|---|---|---|---|---|
| | Dry Weight | Mass | BET | Capacity | Capacity | Capacity |
| Sample Type | Basis (g/g) | (g) | (m²/g) | (w/w) | (mg/cc) | (w/w MOF) |
| UiO-66-NH₂ | 100.0% | 0.3489 | 918 | 0.87% | 3.04 | 0.87% |
| (baseline) | | | | | | |
| 15% SAA-UiO-66- | 85.0% | 0.11883 | 912 | 0.99% | 1.87 | 1.16% |
| NH₂ | | | | | | |
| 15% SAA-UiO-66- | 85.0% | 0.2159 | 963 | 0.58% | 1.24 | 0.68% |
| NH₂ | | | | | | |
| UiO-66- NH₂ SAA | 85.0% | 0.2510 | 919 | 0.92% | 2.32 | 1.08% |
| UiO-66- NH₂ 4.5% | 95.5% | 0.1607 | 1206 | 0.94% | 1.51 | 0.98% |
| Agar | | | | | | |
| UiO-66- NH₂ 9% | 91.0% | 0.1504 | 923 | 0.75% | 1.12 | 0.82% |
| Agar | | | | | | |
| UiO-66- NH₂ 9% | 91.0% | 0.1448 | 896 | 1.11% | 1.60 | 1.22% |
| Agar | | | | | | |
| UiO-66- NH₂ 30% | 70.0% | 0.2242 | 106 | 0.59% | 1.33 | 0.84% |
| Acetyl Cellulose | | | | | | |
| UiO-66- NH₂ 20% | 80.0% | 0.1883 | 765 | 0.68% | 1.28 | 0.85% |
| AC | | | | | | |
| UiO-66- NH₂ 4.5% | 95.5% | 0.2257 | | 0.58% | 1.30 | 0.61% |
| CG | | | | | | |
| UiO-66- NH₂ 7% | 90.0% | 0.1538 | | 0.34% | 0.52 | 0.38% |
| PES 3% PEG | | | | | | |
| UiO-66- NH₂ 15% | 85.0% | 0.2218 | 1115 | 0.94% | 2.09 | 1.11% |
| SAA | | | | | | |
| UiO-66- NH₂ 9% | 91.0% | 0.2022 | 1022 | 0.42% | 0.86 | 0.46% |
| Agar w/9% SAA | | | | | | |
| chelated with | | | | | | |
| 2.13% Citrate | | | | | | |

Flow tests were also conducted using DMMP in a very shallow bed depth and at a GHSV of 208,000 h-1 while avoiding contaminant slippage (maintaining 100%) adsorption for greater than 30 minutes. The results of this test are shown in a graph 700 shown in FIG. 7. This shows that the MOF beads are still active and the pores are open and available for gas phase adsorption of contaminants, and their application in a sorbent bed maintains efficient adsorption. The MOF beads retain their absorptive capabilities in their loose bead form, inserted or compacted into a sorbent bed, and adhered to textile fabrics.

Preferably, more than one MOF is used in the microbead to obtain broad reactivity against multiple chemical warfare agents. Both UiO-66-NH₂ and MOF-808 are known for their individual ability to catalytically degrade chemical warfare agents and their simulants, but they have an unexpected, enhanced efficacy when combined at a certain ratio in the bead. MOF-808 is a 6-connected Zr-MOF constructed from zirconium clusters and 1,3,5-benzenetricarbonxylate linker (H₃BTC).

To improve our ability to collect the MOF-808 and improve our ability to produce microbeads with this MOF, a production/synthesis method to co-generate a mixture of MOF-808 and UiO-66-NH₂ is disclosed herein. This co-generated mixture can then be used to produce microbeads using our current spray microbead synthesis methods which have been demonstrated using UiO-66-NH₂.

To synthesize the mixture MOF-808/UiO-66-NH₂, the typical solvothermal procedure for producing MOF-808 was used with modifications. MOF-808 is typically prepared from a mixture of ZrCl₄ and H₃BTC (molar ratio 3:1), dissolved in a solution of DMF and formic acid (FA) as a modulator and refluxed at 100-110° C. for 72 hours. The final product is washed with DMF and then methanol. MOF-808 produced using this method typically produces very fine particles (93%—0.835 μm) which can be challenging to isolate. For the mixture, modifications include using an additional amount of ZrCl4/aminoterephthalic acid (ATPA) in molar ration 1:1 is used and increasing the amount of DMF based on the additional ingredients for UiO-66-NH₂ preparation. Also, the modulators used for UiO-66-NH₂ originally (HCl and H₂O) were eliminated, because FA is a well known modulator for both MOFs' syntheses.

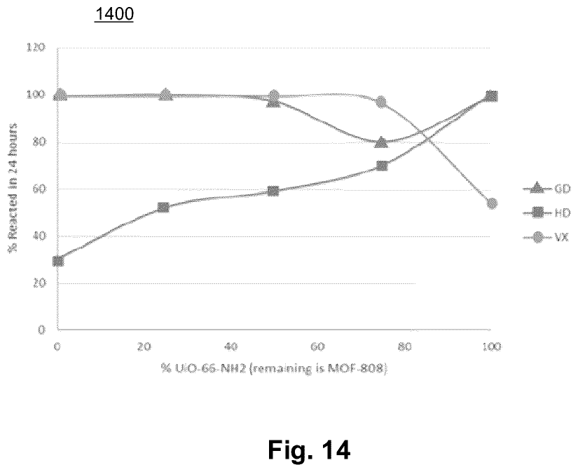

Live agent test results for MOF mixtures of different ratios clearly show that there are reactivity differences between the MOFs and that MOF-808 is clearly better at eliminating VX compared to HD while UiO-66-NH2 is better at eliminating HD compared to VX. Both MOFs are effective against GD. A graphical plot 1400 of these results is shown in FIG. 14. to obtain the greatest reactivity for all these agents, the optimum MOF ratio in the beads is around 80/20 to 90/10, UiO-66-NH2 to MOF-808.

The MOF containing beads are reactive against HD, VX, A-230, and GB among other chemicals and chemical warfare agents. MOF materials containing 80/20 UiO-66-NH₂ to MOF-808 provide the best all-around performance and are the preferred embodiment of this disclosure.

MOFs can be tested in liquid phase and gas phase in reaction vials. 250 mg of reactive beads are placed into a 5-mL glass reaction vial and 20 μL of neat agent is added and evenly spread over the beads for testing.

When 250 mg of MOF containing beads are in a 5 mL reaction vial, the percent agent loss is calculated over a 24 hour period for 20 μL HD, VX, A-230, or G-agents. For HD, at least 90% is eliminated or reduced in concentration in 24 hours. For VX, at least 80% is eliminated or reduced in concentration in 24 hours. For A-230, at least 74% is eliminated or reduced in concentration in 24 hours. For G-agents, at least 86% is eliminated or reduced in concentration in 24 hours. The percent agent loss is calculated by taking the mean sample mass and dividing it by the agent density times delivered volume, then subtracting that value from 1.

The pH of the spray formulation (catalyst-hydrocolloid slurry) is important because it impacts both the solution viscosity and the strength of the MOFs (if the pH is too high the MOF can decompose). The starting pH of the unadjusted alginate MOF mixture is 2.5, and pH adjustments can raise the pH of the sprayed solution. The non-adjusted mixture (^{~}2.5-3) shows a very high viscosity, making spraying difficult. Solutions with a pH of 4 or greater are preferred for a much lower viscosity, as shown in Table 2.

TABLE 2

| pH | 3 | 4 | 5 | 6 | 7 | 8 |
|---|---|---|---|---|---|---|
| Viscosity | 2831 | 383.9 | 479.9 | 503.9 | 503.9 | 407.9 |
| (cP) | | | | | | |

However, when the pH is particularly high (greater than 5), the MOF structure undergoes partial decomposition, in addition to clumping and a decreased surface area, as shown in Table 3. Thus, the preferred pH range for the spray formulation is 4-5.

TABLE 3

| Sample | pH (after) | Viscosity (cP) | BET (m²/g) |
|---|---|---|---|
| 022723A | 4.05 | 45.4 | 766.06 |
| 022723 | 5.10 | 25.5 | 597.38 |
| 022723C | 6.29 | 24.4 | 223.57 |
| 022723D | 7.06 | 26.6 | 0.38 |
| 030123E | 8.01 | 171.7 | — |

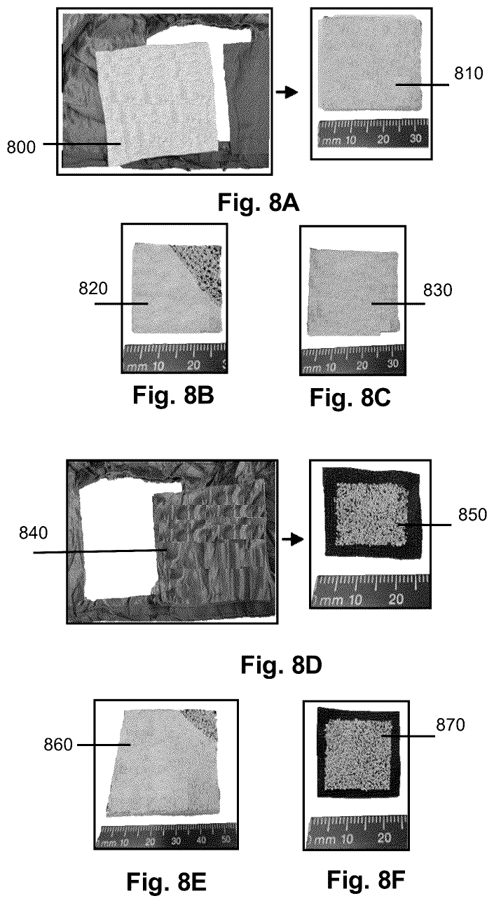

Various methods have been explored to adhere the MOF microbeads into the fabrics used in the Saratoga Hammer Suit (also known as JS-LIST suit) (as shown in FIGS. 8A-8F). FIG. 8A shows a method for adhering MOF microbeads to Saratoga suit with carbon fabric interfacing 800. This may be done by adhering the fabric interfacing 800, with additional interfacing, with elastomer adhesive 810. FIG. 8B also shows a method for adhering MOF microbeads to Saratoga suit 800 is done by adhering the fabric interfacing, with additional interfacing, with elastomer adhesive 820. FIG. 8C shows a method for adhering MOF microbeads to Saratoga suit 800 is done by adhering the fabric interfacing, with additional interfacing, with alginate binder 830.

Alternatively, or in addition to the methods shown in FIGS. 8A-C, FIG. 8D shows adhering the Saratoga suit carbon fabric inner surface 840 with elastomer adhesive 850, FIG. 8E shows adhering the fabric inner surface 840 with a polyurethane binder with additional interfacing 860, and FIG. 8F shows adhering the fabric inner surface 840 with fabric adhesive tape 870.

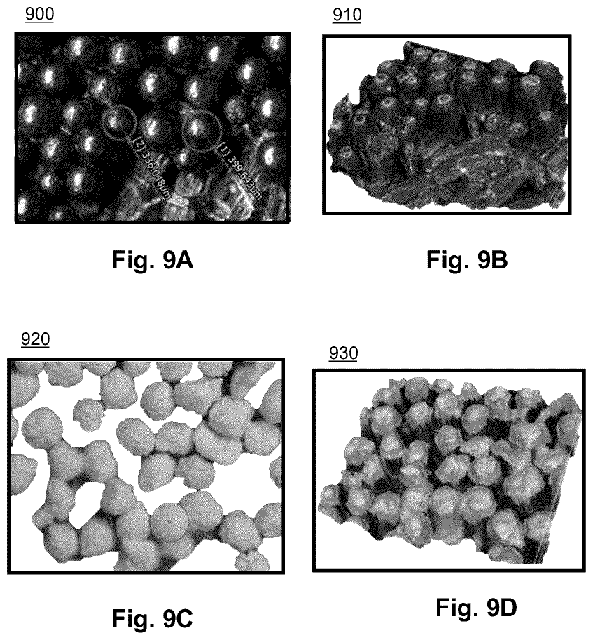

The size of the microbeads was matched to those of the encapsulated carbon particles used in the commercial suit. FIGS. 9A-D shows optical image and 3D rendering of carbon microbeads in the commercial suit and in polymer-encapsulated MOF functionalized fabric. FIG. 9A shows carbon microbeads on Saratoga Hammer Suit via optical image 900, and FIG. 9B shows carbon microbeads on Saratoga Hammer Suit via 3D rendering 910. FIG. 9C shows MOF microbead functionalized fabric via optical image 920, and FIG. 9D shows MOF microbead functionalized fabric via 3D rendering 930.

The commercial suit has carbon beads measuring 336 μm and 400 μm, while the MOF microbeads measure 340 μm and 391 μm.

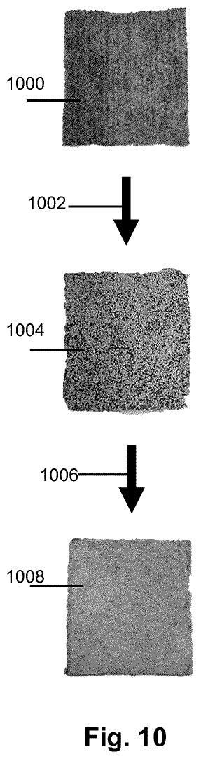

Using a combination of chemical binders and hot-pressing, the beads were successfully incorporated into a fabric. A schematic of adhering and stabilizing the polymer-encapsulated MOF beads on the textile is shown in FIG. 10. A native textile 1000 is sprayed with elastomer spray adhesive 1002, followed by adding patterned and bonded MOF microbeads 1004, which may then enter a textile hot press 1006, and is stabilized with interfacing fabric 1008. The surface density of the microbeads was slightly lower than the currently used carbon microbeads in these initial trials. The DMNP hydrolysis results showed near complete hydrolysis of the simulant by fabric supported MOFs in less than 30 minutes. This compared well against the destruction of DMNP over the native MOF powder in a little less than 20 minutes.

The adhesive method preferably does not coat or destroy the surface area of the MOF microbeads. PEBAX® polymers may be used as a good adhesive to bound alginate beads to fabric surfaces and not coat or destroy the surface area of the MOF alginate beads. Other fabric adhesives, glues, and thermal adhesives all significantly reduce the surface area of the beads, reducing the reactivity surface area.

PEBAX® elastomers are block copolymers made of rigid polyamide blocks and soft polyether blocks. PEBAX® is a thermoplastic elastomer that can be made to have a large range of flexibility, from very hard and rigid to very soft and flexible.

Most adhesives, glues, or thermal adhesives cause a significant reduction in the surface area of the MOF materials. Both low and high loads of PEBAX® produced flexible materials that did not shed MOF particles during manipulation. The mesh remains lightweight and not stiff or rigid. The low MOF loading sample maintains the porous structure of the mesh as small holes remain in the middle of the mesh. The surface area of the blank mesh was essentially zero, while the surface area of the low MOF loading sample was 262 m²/g. The high loading mesh remains flexible, though all the mesh holes are filled with reactive MOF material and may not be as breathable (though the protective performance is very good). Microscope images show that PEBAX® forms a web type bounding to the MOF material instead of coating the materials, so the reactive surface area is minimally affected. Alternative adhesives may be used that do not coat or destroy the reactive surface area and maintain flexibility of the fabric.

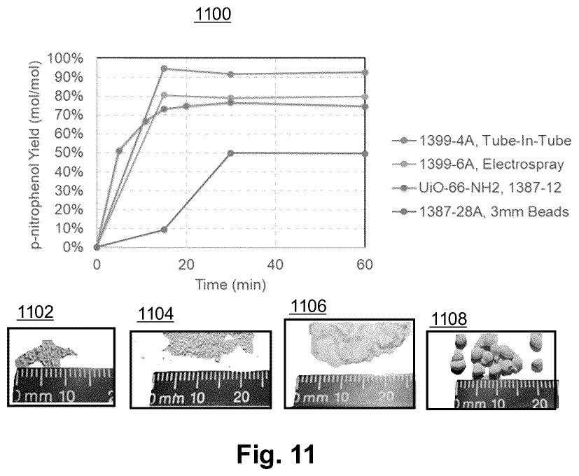

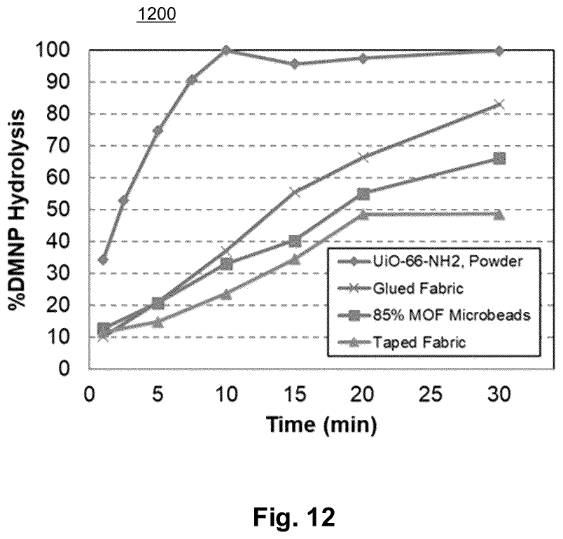

FIG. 11 shows a graph 1100 of the yield of p-nitrophenoxide from DMNP hydrolysis using UiO-66-NH₂ native powder and varying sizes of polymer-encapsulated MOF beads. FIG. 11 also shows examples of tube-in-tube rods 1102, electrospray beads 1104, UiO-66-NH₂ powder 1106, and manual drop beads 1108 for reference. FIG. 12 shows a graph 1200 of the comparative performance of native UiO-66-NH₂ powder compared to synthesized 85% MOF microbeads on their own (MOF loading=6.7 mg), glued to fabric (MOF loading=4.7 mg), and adhered to fabric using fabric tape (MOF loading=10.3 mg), where the fabric is 50% nylon-50% cotton and reactions were performed at room temperature.

This disclosure describes a recipe and method to encapsulate metal organic frameworks, or other catalysts/sorbents, into a porous polymer using electrospray. We then patterned these synthesized microbeads onto textiles, making these functionalized fabrics capable of rapidly decontaminating chemical warfare agents or simulants like DEVX. It provides a recipe for combining metal organic frameworks and polymers to produce an active sorbent/catalyst encased in a polymer. It provides a method for encapsulating metal organic frameworks, catalysts, or sorbents in a porous polymer microbead synthesized via electrospray. It also provides a method for creating a textile coated in MOF microbeads, such that the fabric can decontaminate chemical warfare agents like DEVX.

What is claimed is:

1. A MOF formulation for protection against chemical warfare agents (CWAs) comprising:
a) UiO-66-NH₂; and,
b) MOF-808;
wherein, the MOF formulation comprises 80-90% UiO-66-NH₂ by weight and 10-20% MOF-808 by weight.

2. The MOF formulation as in claim 1, wherein the MOF formulation is prepared by a single pot synthesis.

3. The MOF formulation as in claim 1, wherein the MOF formulation can reduce the concentration of VX or HD in solution by at least 75% when 250 g of MOF formulation is in contact with 20 μL of VX or HD in solution for 24 hours.

4. A polymer-encapsulated catalyst for protection against CWAs comprising:
a) the MOF formulation as in claim 1; and,
b) a polymer shell surrounding the MOF formulation;
wherein, the polymer-encapsulated catalyst is a rounded bead;
wherein, the polymer-encapsulated catalyst has a diameter of 100-800 μm; and,
wherein, the polymer-encapsulated catalyst comprises 70-85% MOF formulation by weight and 15-30% polymer by weight.

5. The polymer-encapsulated catalyst as in claim 4, wherein the polymer shell comprises a hydrocolloid.

6. The polymer-encapsulated catalyst as in claim 5, wherein the hydrocolloid is selected from the group comprising: agars, starches, celluloses, xanthan, gelatins, casein, alginates, carrageenans, amino sugars, and pectins.

7. The polymer-encapsulated catalyst as in claim 4, wherein the polymer-encapsulated catalyst has a diameter of 200-400 μm.

8. A method for encapsulating a catalyst with a polymer for protection against chemical warfare agents comprising the steps:
a) generating a catalyst, wherein the catalyst absorbs and neutralizes toxic materials;
b) dispersing the catalyst in a hydrocolloid solution, thereby forming a catalyst-hydrocolloid slurry; and,
c) spraying the catalyst-hydrocolloid slurry through a spraying nozzle and into a gelling solution comprising a gelling agent.

9. The method as in claim 8, wherein the catalyst is at least one MOF.

10. The method as in claim 9, wherein the catalyst is a combination of UiO-66-NH₂ and MOF-808.

11. The method as in claim 10, wherein the catalyst comprises 80-90% UiO-66-NH₂ by weight and 10-20% MOF-808 by weight.

12. The method as in claim 10, wherein generating a catalyst comprises co-generating UiO-66-NH₂ and MOF-808 in a single pot synthesis.

13. The method as in claim 10, wherein, the catalyst-hydrocolloid slurry has a pH of 4-5.

14. The method as in claim 8, wherein the spraying nozzle is an electrospray nozzle or a pneumatic spray nozzle.

15. The method as in claim 8, wherein the hydrocolloid is selected from the group comprising:
agars, starches, celluloses, xanthan, gelatins, casein, alginates, carrageenans, amino sugars, and pectins.

16. The method as in claim 8, further comprising the step:
d) collecting a plurality of polymer-encapsulated catalysts from the gelling solution, wherein each polymer-encapsulated catalyst has a diameter of 100-800 μm.

17. The method as in claim 16, wherein the polymer-encapsulated catalysts comprise 70-85% MOF formulation by weight and 15-30% polymer by weight.

18. A method for encapsulating MOFs with polymers for use in textiles, the steps comprising:
a) generating a catalyst, wherein the catalyst is reactive with nerve and blister chemical warfare agents;
b) dispersing the catalyst in a hydrocolloid solution, thereby forming a catalyst-hydrocolloid slurry;
c) spraying the catalyst-hydrocolloid slurry through a spraying nozzle and into a gelling solution comprising a gelling agent;
d) collecting and drying a plurality of polymer-encapsulated catalysts from the gelling solution, wherein each polymer-encapsulated catalyst has a diameter of 100-800 μm; and,
e) adhering the plurality of polymer-encapsulated catalysts to a textile such that the textile retains its flexibility, and such that the textile can be assembled into a wearable suit or garment, wherein the wearable suit or garment protects a wearer in an environment contaminated with nerve and blister chemical warfare agents.

19. The method as in claim 18, wherein adhering the plurality of polymer-encapsulated catalysts to a textile comprises using an adhesive to attach the polymer-encapsulated catalysts to the textile, wherein the adhesive does not completely coat or destroy the surface area of the polymer-encapsulated catalysts.

20. The method as in claim 18, wherein the adhesive is a thermoplastic elastomer adhesive.

21. The method as in claim 18, wherein the catalyst is at least one MOF.

22. The method as in claim 21, wherein the catalyst is a combination of UiO-66-NH₂ and MOF-808, wherein the catalyst is 80-90% UiO-66-NH₂ by weight and 10-20% MOF-808 by weight.
